(19) United States
(12) Patent Application Publication
(10) Pub. No.: US 2006/0154841 A1
(43) Pub. Date: Jul. 13, 2006

(54) Pressed shaped bodies comprising coated sodium percarbonate particles

(75) Inventors: Harald Jakob, Hasselroth (DE); Klaus Zimmermann, Rodenbach (DE)

Correspondence Address: FITCH, EVEN, TABIN & FLANNERY, P. O. BOX 65973, WASHINGTON, DC, 20035, US

(73) Assignee: Degussa AG, Dusseldorf (DE)

(21) Appl. No.: 11/301,330

(22) Filed: Dec. 13, 2005

(30) Foreign Application Priority Data
Dec. 14, 2004 (DE) 10 2004 060 011.2

(51) Int. Cl. C11D 3/39

(52) U.S. Cl. 510/312

(57) ABSTRACT

Pressed shaped bodies comprising coated sodium percarbonate particles having an inner shell layer which comprises one or more water-soluble, hydrate-forming salts and an outer layer on top of this which comprises an alkali metal silicate have an improved storage stability with a lower loss of active oxygen. The shaped bodies preferably additionally comprise at least one surfactant and optionally further wash-active substances. The shaped bodies can be produced by tabletting or briquetting from a pulverulent mixture. The shaped bodies can be used in detergents or cleaning compositions.

### CROSS REFERENCE TO RELATED APPLICATIONS

The present application claims priority to German application 10 2004 060 011.2, filed on Dec. 14, 2004, the content of which is hereby incorporated by reference.

### FIELD OF THE INVENTION

The invention relates to pressed shaped bodies which comprise coated sodium percarbonate particles and which have improved storage stability with a low loss of active oxygen content.

### BACKGROUND OF THE INVENTION

Sodium percarbonate is increasingly being employed as a bleaching-active constituent in detergents and cleaning agents. For this use, sodium percarbonate must have an adequate storage stability in detergent and cleaning agent formulations, since an undesirable loss of active oxygen and therefore of bleaching action otherwise occurs during storage of the detergents and cleaning agents. Sodium percarbonate is moisture-sensitive and decomposes in detergent and cleaning agent formulations under the action of moisture, with loss of active oxygen. Sodium percarbonate is therefore conventionally employed in a coated form for the preparation of detergents or cleaning agents, the shell layer preventing the action of moisture on the coated sodium percarbonate. Suitable shell layers of inorganic, hydrate-forming salts, such as, for example, sodium carbonate, sodium sulfate or magnesium sulfate and mixtures of such salts, are known, for example, from DE 24 17 572, EP-A 0 863 842 and U.S. Pat. No. 4,325,933.

Detergents and cleaning agents are also increasingly being marketed in the form of pressed shaped bodies, which have advantages for the user, such as, for example, clean handling without the formation of dust or spilling of a powder and a lower tendency towards the development of caking in the washing-in chamber of a washing machine. Pressed shaped bodies also have advantages in the metering of detergents and cleaning agents if shaped bodies are used in the form of tablets or blocks in a size which contains the amount of detergent or cleaning agent required for one washing operation in a washing machine or dishwasher.

If sodium percarbonate particles which have been coated to improve the storage stability are used for the production of pressed shaped bodies, however, the problem arises that due to the mechanical stress on the sodium percarbonate particles during the pressing operation required for production of the shaped bodies, the shell layer of the particles is damaged and the sodium percarbonate therefore has a lower storage stability in the shaped bodies produced than in the particles employed. A more rapid loss of the content of active oxygen therefore occurs in the shaped bodies comprising sodium percarbonate than in the sodium percarbonate particles employed for the production of the shaped bodies. There is therefore a need for pressed shaped bodies which comprise sodium percarbonate particles and which have an improved storage stability with a low loss of active oxygen content.

EP-A 0 634 478, EP-A 0 672 749 and EP-A 0 690 122 disclose machine dishwashing agents which comprise a bleaching agent which releases oxygen. Sodium perborate and sodium percarbonate are mentioned as preferred bleaching agents. In this context, sodium percarbonate is preferably employed in a coated form, a mixed salt of an alkali metal sulfate and an alkali metal carbonate being mentioned as the preferred coating material. Sodium silicate having an SiO₂:Na₂O ratio of from 1.6 to 3.4 is likewise mentioned as a suitable coating material. The documents moreover disclose that the machine dishwashing agents can be formulated in the form of powders, granules, pastes, liquids, gels or tablets. However, no teaching as to how sodium percarbonate particles must be coated so that they are sufficiently storage-stable in pressed shaped bodies and show no increased loss of active oxygen content is to be found in the documents.

WO 97/45524 discloses detergent formulations which comprise an alkaline component with delayed release. These detergent formulations can comprise as a bleaching constituent organic peracids or inorganic perhydrates, sodium perborate and sodium percarbonate being mentioned as preferred inorganic perhydrates. The inorganic perhydrates are preferably used in a form with delayed release, a coating with sodium silicate having an SiO₂:Na₂O ratio of from 1.6 to 3.4 being mentioned as a form of delayed release which is preferred for sodium percarbonate. The detergent formulations described in this document can have the form of granules, tablets, blocks or liquids. However, it cannot be seen from the document how sodium percarbonate particles must be coated so that they are sufficiently storage-stable in pressed shaped bodies and show no increased loss of active oxygen content.

WO 97/03177 discloses machine dishwashing agents in tablet form which comprise sodium perborate as a bleaching agent. Sodium percarbonate, preferably in coated form, can also be employed instead of sodium perborate. However, no teaching as to how the coating of sodium percarbonate particles must be built up so that tablets which comprise these sodium percarbonate particles have an adequate storage stability with a low loss of active oxygen content is to be found in the document.

EP-A 0 992 575 discloses sodium percarbonate particles which comprise an alkali metal silicate having a molar ratio of SiO₂ to alkali metal oxide of more than 3 and less than 5. In this context, the particles can contain the alkali metal silicate both in the core and in a shell layer. The sodium percarbonate particles described are preferably coated with one or more shell layers, water-soluble organic stabilizers, water-soluble magnesium compounds and alkali metal carbonates, bicarbonates and sulfates also being mentioned, in addition to the alkali metal silicate, as suitable constituents of the shell layers. The document moreover discloses as suitable detergents, dishwashing agents or bleaching agents formulations which comprise such sodium percarbonate particles and which can have the form of free-flowing particles or the form of tablets for a washing operation. However, no teaching as to how the shell layer of sodium percarbonate particles must be built up so that pressed shaped bodies which comprise such sodium percarbonate particles have an adequate storage stability with a low loss of active oxygen content is to be found in the document.

EP-A 0 737 738 discloses bleaching tablets which comprise 45 to 85 wt % of coated sodium percarbonate and 1 to 50 wt % of layered silicate or alkali metal silicate having a composition of SiO₂:Na₂O in the range of from 1 to 3.5 and which have a high storage stability. The composition of the shell layer is disclosed in this document by only two products described by way of example, one of which has a boron-containing shell layer and the other of which has a shell layer based on sulfate and sodium carbonate. The document teaches on page 2 in lines 25 to 28 that during the production of tablets, the shell layer of the sodium percarbonate is partly or completely destroyed by the high pressing pressure used for the tablet-making, and that this leads to a severe loss of the protective action of the shell layer. Furthermore, no indications that the composition of the shell layer of the sodium percarbonate particles has an influence on the storage stability of the tablets are to be found in the document.

WO 00/71666 discloses detergent tables which comprise coated sodium percarbonate particles, the coating being made of a water-soluble material. Suitable coating materials which are mentioned are sodium sulfate, sodium carbonate, sodium chloride and sodium borate, as well as mixtures of these materials. However, no indications that the composition of the shell layer of the sodium percarbonate particles has an influence on the storage stability of the tablets are to be found in the document.

WO 01/34759 discloses detergent tablets which comprise a bleaching agent. Bleaching agents which are mentioned are perborates, percarboxylic acids and peroxygen compounds, sodium percarbonate being mentioned as the preferred peroxygen compound. In this context, the sodium percarbonate can be coated with silicate, borate or water-soluble surfactants. However, no indications that the composition of the shell layer of the sodium percarbonate particles has an influence on the storage stability of the tablets are to be found in the document.

WO 2004/056954 discloses coated sodium percarbonate particles which have two shell layers. The inner shell layer comprises at least one hydrate-forming inorganic salt and makes up 2 to 20 wt. % of the particles. The outer shell layer comprises an alkali metal silicate having an SiO₂:M₂O (M=alkali metal) modulus of greater than 2.5 and makes up 0.2 to 3 wt. % of the particles. As can be seen from Examples 17 and 18 and Table 7 of the Application, in a pulverulent detergent formulation these sodium percarbonate particles show a higher storage stability and a lower loss of active oxygen than sodium percarbonate particles on which the outer shell layer is lacking. However, no indications that these sodium percarbonate particles can be used in pressed shaped bodies and as to the effect the pressing operation has on the stability of the sodium percarbonate particles are to be found in the document.

It has now been found, surprisingly, that the object of providing pressed shaped bodies comprising coated sodium percarbonate particles, which have an improved storage stability with a relatively low loss of active oxygen content, can be achieved if the coating of the sodium percarbonate particles has an inner shell layer with at least one water-soluble, hydrate-forming salt and an outer shell layer with an alkali metal silicate.

### DESCRIPTION OF THE INVENTION

The present invention provides pressed shaped bodies comprising coated sodium percarbonate particles, characterized in that the coating of the sodium percarbonate particles comprises an inner shell layer comprising one or more water-soluble, hydrate-forming salts and an outer shell layer on top of this comprising an alkali metal silicate.

The invention moreover also relates to the use of the pressed shaped bodies according to the invention in detergents or cleaning agents, and to the use of pressed shaped bodies according to the invention which additionally comprise at least one surfactant as detergents or cleaning agents.

The present invention furthermore provides a process for the production of shaped bodies comprising coated sodium percarbonate particles, characterized in that a pulverulent mixture comprising coated sodium percarbonate particles is compacted by tabletting or briquetting, the coated sodium percarbonate particles having a coating with an inner shell layer comprising one or more water-soluble, hydrate-forming salts and an outer shell layer on top of this comprising an alkali metal silicate.

The coated sodium carbonate particles contained in the shaped bodies according to the invention comprise a core which substantially comprises sodium carbonate perhydrate of the composition 2Na₂CO₃3H₂O₂. They can moreover also comprise small amounts of known stabilizers for peroxygen compounds, such as, for example, magnesium salts, silicates, phosphates and/or chelating complexing agents. The content of sodium percarbonate in the core of the sodium percarbonate particles according to the invention is preferably more than 95 wt. % and particularly preferably more than 98 wt. %. The content of organic carbon compounds in the core is preferably less than 1 wt. %, particularly preferably less than 0.1 wt. %.

In a preferred embodiment, the core comprises small amounts of additives which have a stabilizing action on the active oxygen content, the content of stabilizing additives in the core preferably being less than 2 wt. %. Stability-increasing additives which are preferably used are magnesium salts, water-glass, stannates, pyrophosphates, polyphosphates and chelating complexing agents from the series consisting of hydroxycarboxylic acids, aminocarboxylic acids, aminophosphonic acids, phosphonocarboxylic acids and hydroxyphosphonic acids and alkali metal, ammonium or magnesium salts thereof. In a particularly preferred embodiment, the core comprises as the stabilizing additive an alkali metal silicate, preferably water-glass having an SiO₂/Na₂O modulus in the range of from 1 to 3, in an amount of from 0.1 to 1 wt. %. In the most preferred embodiment, the core also comprises a magnesium compound in an amount of from 50 to 2,000 ppm Mg²⁺ in addition to this amount of alkali metal silicate.

The core of the coated sodium percarbonate particles can be produced by one of the known preparation processes for sodium percarbonate. A suitable preparation process for sodium percarbonate is the crystallization of sodium percarbonate from aqueous solutions of hydrogen peroxide and sodium carbonate, it being possible for the crystallization to be carried out both in the presence and in the absence of a salting-out agent, for which reference is made by way of example to EP-A 0 703 190. Sodium percarbonate particles prepared by the crystallization process in the presence of a salting-out agent can also comprise small amounts of the salting-out agent used, such as e.g. sodium chloride. Fluidized bed build-up granulation by spraying aqueous hydrogen peroxide solution and aqueous soda solution onto sodium percarbonate seeds in a fluidized bed with simultaneous evaporation of water is likewise suitable, reference being made by way of example to WO 95/06615. The reaction of solid sodium carbonate with an aqueous hydrogen peroxide solution and subsequent drying is furthermore also a suitable preparation process. The core of the coated sodium percarbonate particles is preferably obtained by fluidized bed build-up granulation. Coated sodium percarbonate particles, the core of which has been prepared by fluidized bed build-up granulation, show an improved storage stability in the pressed shaped bodies according to the invention compared with particles in which the core has been prepared by another process.

The coated sodium percarbonate particles contained in the shaped bodies according to the invention also comprise, in addition to the core of sodium percarbonate, an inner shell layer which comprises a water-soluble, hydrate-forming salt and an outer shell layer which comprises an alkali metal silicate.

The inner shell layer preferably comprises one or more inorganic, hydrate-forming salts. Inorganic, hydrate-forming salts in the context of the invention are salts which can bond water in the crystal lattice, contain no organic radicals and are not oxidized by sodium percarbonate.

In addition, to this inner and outer shell layer, the coated sodium percarbonate particles can also comprise one or more further shell layers, it being possible for these to be arranged both between the core and the inner shell layer and between the inner and the outer shell layer as well as outside the outer shell layer.

A sharp boundary at which the composition changes suddenly can exist between the shell layers and between the innermost shell layer and the core. As a rule, however, a transition zone which comprises the components of the two layers adjacent to one another will form in each case between the individual shell layers and between the innermost shell layer and the core. Such transition zones are formed, for example, by application of a shell layer in the form of an aqueous solution, at the start of the build-up of the layer some of the layer lying underneath being superficially dissolved, so that a transition zone forms which comprises the constituents of the two layers. A transition layer which comprises sodium percarbonate, sodium carbonate, sodium bicarbonate and the water-soluble, hydrate-forming salt of the inner shell layer can thus form between the core and the inner shell layer. In a similar manner, a transition layer which comprises the water-soluble, hydrate-forming salt of the inner shell layer and the alkali metal silicate of the outer shell layer can form between the inner shell layer and the outer shell layer.

The inner shell layer and outer shell layer are preferably formed such that they cover the material lying underneath to the extent of more than 95%, preferably to the extent of more than 98% and in particular completely.

The inner shell layer of the coated sodium percarbonate particles contained in the shaped bodies according to the invention preferably comprises one or more hydrate-forming salts of an alkali metal and/or alkaline earth metal as the water-soluble, hydrate-forming salt. The water-soluble, hydrate-forming salt is preferably chosen from the series consisting of sodium sulfate, sodium carbonate, sodium bicarbonate or magnesium sulfate. Mixtures and mixed salts of these compounds are also suitable. The inner shell layer particularly preferably comprises sodium sulfate as the inorganic, hydrate-forming salt. The content of water-soluble, hydrate-forming salt in the material of the inner shell layer is preferably at least 50 wt. %, particularly preferably at least 90 wt. %. The content of the inner shell layer in the coated sodium percarbonate particles is preferably in the range of from 1 to 10 wt. %, particularly preferably in the range of from 2 to 7 wt. %. The weight contents are in each case calculated for the inorganic, hydrate-forming salt in the anhydrous form. In a particularly preferred embodiment, the inner shell layer substantially consists of sodium sulfate.

The application of the inner shell layer is preferably carried out by spraying on an aqueous solution in which at least one hydrate-forming salt is dissolved. In addition to the dissolved hydrate-forming salt, the aqueous solution preferably contains no further dissolved components in weight contents which are greater than the weight of the dissolved, hydrate-forming inorganic salt, calculated in the anhydrous form. The inner shell layer is particularly preferably applied by spraying on an aqueous sodium sulfate solution. During spraying on of the aqueous solution, the majority of the water contained therein, in particular more than 90% of the water contained in the aqueous solution, is preferably already evaporated by introduction of heat, so that only a small part of the core material is superficially dissolved again during application of the inner shell layer and a firm shell layer which comprises the hydrate-forming salt is already formed during the spraying on. The inner shell layer is preferably applied by spraying an aqueous solution containing the hydrate-forming salt into a fluidized bed and particularly preferably by the process described in EP-A 0 970 917, with which a dense shell layer can already be achieved with small amounts of shell layer material. The application of the inner shell layer in a fluidized bed is preferably carried out while feeding a drying gas to the fluidized bed such that a temperature in the range of from 30 to 90° C. is established in the fluidized bed.

The outer shell layer of the coated sodium percarbonate particles contained in the shaped bodies according to the invention comprises an alkali metal silicate, which preferably has a modulus of SiO₂ to alkali metal oxide of more than 2.5 and particularly preferably a modulus in the range of from 3 to 5, the modulus designating the molar ratio of SiO₂ to alkali metal oxide. The content of alkali metal silicate in the material of the outer shell layer is preferably at least 50 wt. %, particularly preferably at least 90 wt. %. The amount of alkali metal silicate contained in the outer shell layer is preferably 0.2 to 3 wt. % and preferably 0.3 to 1 wt. %, based on the total amount of coated sodium percarbonate particles. The alkali metal silicate is preferably a sodium silicate and particularly preferably a soda water-glass.

The outer shell layer is preferably applied by spraying on an aqueous solution containing an alkali metal silicate. Preferably, an aqueous solution having a concentration of alkali metal silicate in the range of from 2 to 20 wt. %, particularly preferably 3 to 15 wt. % and in particular 5 to 10 wt. % is used here. A so-called water-glass solution is preferably sprayed on for application of a shell layer substantially of sodium silicate. During spraying on of the aqueous solution containing an alkali metal silicate, the majority of the water contained therein, in particular more than 90% of the water contained in the aqueous solution, is preferably already evaporated by introduction of heat, so that only a small part of the material lying underneath is superficially dissolved again during application of the outer shell layer and a firm shell layer containing alkali metal silicate is already formed during the spraying on. The outer shell layer is preferably applied by spraying the aqueous solution containing alkali metal silicate in a fluidized bed and particularly preferably by the process described in EP-A 0 970 917, with which a dense shell layer can already be achieved with small amounts of shell layer material. The application of the outer shell layer in a fluidized bed is preferably carried out while feeding a drying gas to the fluidized bed such that a temperature in the range of from 30 to 90° C. is established in the fluidized bed.

Coated sodium percarbonate particles which comprise an alkali metal silicate having a modulus of SiO₂ to alkali metal oxide of more than 2.5 in the outer shell layer show an increased dissolving time during dissolving in water, in particular if the outer shell layer has been applied by spraying on an aqueous solution having a concentration of alkali metal silicate in the range of from 2 to 20 wt. %. Shaped bodies according to the invention which comprise such coated sodium percarbonate particles of increased dissolving time together with one or more enzymes show an improved activity as detergents or cleaning agents. The increased dissolving time of the coated sodium percarbonate particles has the effect of a delayed release of hydrogen peroxide, so that the enzymes can act over a longer period of time before deactivation of the enzymes by hydrogen peroxide or denaturing of enzymatically degradable proteins by hydrogen peroxide occurs.

The sodium percarbonate particles contained in the shaped bodies according to the invention preferably have an average particle size in the range of from 0.2 to 5 mm and particularly preferably in the range of from 0.5 to 2 mm. The shaped bodies according to the invention preferably comprise sodium percarbonate particles having a low fine particle content, preferably having a content of less than 10 wt. % of particles smaller than 0.2 mm and particularly preferably less than 10 wt. % of particles having a particle size of less than 0.3 mm.

The sodium percarbonate particles contained in the shaped bodies according to the invention preferably have a substantially spherical shape with a smooth surface. Particles having a smooth surface have a surface roughness of less than 10% of the particle diameter and preferably of less than 5% of the particle diameter.

The storage stability of the shaped bodies according to the invention can be improved further by an appropriate choice of the particle size and particle shape of the sodium percarbonate particles.

The pressed shaped bodies according to the invention preferably comprise between 1 and 90 wt. % and particularly preferably between 5 and 40 wt. % of the coated sodium percarbonate particles described above.

The pressed shaped bodies according to the invention preferably also comprise, in addition to the coated sodium percarbonate particles, at least one surfactant, surfactants which are suitable for detergents and cleaning agents preferably being chosen. The pressed shaped bodies according to the invention can moreover also additionally comprise further constituents which are suitable for detergents and cleaning agents, preferably those from the series consisting of builders, alkaline components, bleaching activators, enzymes, chelating complexing agents, greying inhibitors, foam inhibitors, optical brighteners, corrosion protection agents for silver, fragrances and dyestuffs.

Suitable surfactants for the pressed shaped bodies according to the invention are, above all, anionic, nonionic and cationic surfactants. Suitable anionic surfactants are, for example, surfactants having sulfonate groups, preferably alkylbenzenesulfonates, alkanesulfonates, alpha-olefinsulfonates, alpha-sulfo-fatty acid esters or sulfosuccinates. In the case of alkylbenzenesulfonates, those having a straight-chain or branched alkyl group having 8 to 20 carbon atoms, in particular having 10 to 16 carbon atoms, are preferred. Preferred alkanesulfonates are those having straight-chain alkyl chains having 12 to 18 carbon atoms. In the case of alpha-olefinsulfonates, the reaction products of the sulfonation of alpha-olefins having 12 to 18 carbon atoms are preferably employed. In the case of the alpha-sulfo-fatty acid esters, sulfonation products of fatty acid esters of fatty acids having 12 to 18 carbon atoms and short-chain alcohols having 1 to 3 carbon atoms are preferred. Surfactants having a sulfate group in the molecule, preferably alkyl sulfates and ether sulfates, are also suitable anionic surfactants. Preferred alkyl sulfates are those having straight-chain alkyl radicals having 12 to 18 carbon atoms. Beta-branched alkyl sulfates and alkyl sulfates mono- or polysubstituted by alkyl in the middle of the longest alkyl chain are furthermore suitable. Preferred ether sulfates are the alkyl ether sulfates which are obtained by ethoxylation of linear alcohols having 12 to 18 carbon atoms with 2 to 6 ethylene oxide units and subsequent sulfation. Finally, soaps can also be used as anionic surfactants, such as, for example, alkali metal salts of lauric acid, myristic acid, palmitic acid, stearic acid and/or naturally occurring fatty acid mixtures, such as, for example, coconut, palm kernel or tallow fatty acids.

Suitable nonionic surfactants are, for example, alkoxylated compounds, in particular ethoxylated and propoxylated compounds. Condensation products of alkylphenols or fatty alcohols with 1 to 50 mol, preferably 1 to 10 mol of ethylene oxide and/or propylene oxide are particularly suitable. Polyhydroxy-fatty acid amides in which an organic radical having one or more hydroxyl groups, which can also be alkoxylated, is bonded to the amide nitrogen are likewise suitable. Alkyl glycosides having a straight-chain or branched alkyl group having 8 to 22 carbon atoms, in particular having 12 to 18 carbon atoms, and a mono- or diglycoside radical, which is preferably derived from glucose, are likewise suitable as nonionic surfactants.

Suitable cationic surfactants are, for example, mono- and dialkoxylated quaternary amines having a C₆- to C₁₈-alkyl radical bonded to the nitrogen and one or two hydroxyalkyl groups.

The pressed shaped bodies according to the invention can furthermore comprise builders which are capable, during use, of bonding calcium and magnesium ions dissolved in the water. Suitable builders are alkali metal phosphates and alkali metal polyphosphates, in particular pentasodium triphosphate; water-soluble and water-insoluble sodium silicates, in particular layered silicates of the formula Na₅Si₂O₅; zeolites of the structures A, X and/or P; and trisodium citrate. In addition to the builders, organic co-builders, such as, for example, polyacrylic acid, polyaspartic acid and/or acrylic acid copolymers with methacrylic acid, acrolein or vinyl monomers containing sulfonic acid, as well as alkali metal salts thereof, can furthermore be used.

The pressed shaped bodies according to the invention can comprise, in addition to the coated sodium percarbonate particles contained therein, further alkaline components which, when used as intended in a wash liquor or an aqueous cleaning agent solution, effect a pH in the range of from 8 to 12. Suitable alkaline components are, above all, sodium carbonate, sodium sesquicarbonate, sodium metasilicate and other soluble alkali metal silicates.

The pressed shaped bodies according to the invention can furthermore also comprise bleaching activators. Preferred bleaching activators are compounds having one or more acyl groups bonded to nitrogen or to oxygen which are capable of perhydrolysis and react in a wash liquor or an aqueous cleaning agent solution with the hydrogen peroxide released from the sodium percarbonate particles to give peroxycarboxylic acids. Examples of such compounds are polyacylated alkylenediamines, such as, in particular, tetraacetylethylenediamine (TAED); acylated triazine derivatives, in particular 1,5-diacetyl-2,4-dioxohexahydro-1,3,5-triazine (DADHT); acylated glycol urils, in particular tetraacetylglycol uril (TAGU); N-acylimides, in particular N-nonanoylsuccinimide (NOSI); acylated phenolsulfonates, in particular n-nonanoyl- or iso-nonanoyloxybenzenesulfonate (n- or iso-NOBS); carboxylic acid anhydrides, such as phthalic anhydride; acylated polyhydric alcohols, such as ethylene glycol diacetate, 2,5-diacetoxy-2,5-dihydrofuran, acetylated sorbitol and mannitol and acylated sugars, such as pentaacetylglucose; enol esters; and N-acylated lactams, in particular N-acylcaprolactams and N-acylvalerolactams. Amino-functionalized nitriles and salts thereof (nitrile quats), which are known, for example, from the journal Tenside Surf. Det. 1997, 34(6), pages 404-409, are likewise suitable as bleaching activators. Transition metal complexes which can activate hydrogen peroxide for bleaching removal of spots can furthermore be employed as bleaching activators. Suitable transition metal complexes are known, for example, from EP-A 0 544 490 page 2, line 4 to page 3, line 57; WO 00/52124 page 5, line 9 to page 8, line 7 and page 8, line 19 to page 11, line 14; WO 04/039932, page 2, line 25 to page 10, line 19; WO 00/12808 page 6, line 29 to page 33, line 29; WO 00/60043 page 6, line 9 to page 17, line 22; WO 00/27975, page 3, line 7 to page 4, line 6; WO 01/05925, page 1, line 26 to page 3, line 13; WO 99/64156, page 2, line 25 to page 9, line 18; and GB-A 2 309 976, page 3, line 1 to page 8, line 32.

The pressed shaped bodies according to the invention can moreover comprise enzymes which intensify the cleaning action, in particular lipases, cutinases, amylases, neutral and alkaline proteases, esterases, cellulases, pectinases, lactases and/or peroxidases. In this context, the enzymes can be adsorbed on carrier substances or embedded in coating substances in order to protect them from decomposition.

The pressed shaped bodies according to the invention can moreover comprise chelating complexing agents for transition metals, with which a catalytic decomposition of active oxygen compounds in a wash liquor or an aqueous cleaning agent solution can be avoided. Suitable agents are, for example, phosphonates, such as hydroxyethane-1,1-diphosphonate, nitrilotrimethylenephosphonate, diethylenetriamine-penta(methylenephosphonate), ethylenediamine-tetra(methylenephosphonate), hexamethylenediamine-tetra (methylenephosphonate) and alkali metal salts thereof. Nitrilotriacetic acid and polyaminocarboxylic acids, such as, in particular, ethylenediaminetetraacetic acid, diethylenetriaminepentaacetic acid, ethylenediamine-N,N′-disuccinic acid, methylglycine-diacetic acid and polyaspartates, as well as alkali metal and ammonium salts thereof, are likewise suitable. Finally, polybasic carboxylic acids and, in particular, hydroxycarboxylic acids, such as, in particular, tartaric acid and citric acid, are also suitable as chelating complexing agents.

For a use in detergents or as detergents, the pressed shaped bodies according to the invention can additionally comprise greying inhibitors which keep dirt detached from fibres in suspension and prevent re-absorption of the dirt onto the fibres. Suitable greying inhibitors are, for example, cellulose ethers, such as carboxymethylcellulose and alkali metal salts thereof, methylcellulose, hydroxyethylcellulose and hydroxypropylcellulose. Polyvinylpyrrolidone is likewise suitable.

The pressed shaped bodies according to the invention can furthermore also comprise foam inhibitors which reduce foam formation in a wash liquor. Suitable foam inhibitors are, for example, organopolysiloxanes, such as polydimethylsiloxane, paraffins and/or waxes, as well as mixtures thereof with finely divided silicas.

For a use in detergents or as detergents, the pressed shaped bodies according to the invention can optionally comprise optical brighteners which adsorb onto the fibres, absorb light in the UV range and show blue fluorescence, in order to compensate yellowing of the fibres. Suitable optical brighteners are, for example, derivatives of diaminostilbenedisulfonic acid, such as alkali metal salts of 4,4′-bis-(2-anilino-4-morpholino-1,3,5-triazinyl-6-amino)-stilbene-2,2′-disulfonic acid, or substituted diphenylstyryls, such as alkali metal salts of 4,4′-bis-(2-sulfostyryl)-diphenyl.

For a use as machine dishwashing agents, the pressed shaped bodies according to the invention can moreover also comprise corrosion protection agents for silver which prevent or reduce tarnishing of nonferrous metals, in particular silver, during mechanical cleaning with the machine dishwashing agent. Corrosion protection agents for silver which are preferably employed are one or more compounds from the series consisting of triazoles, benzotriazoles, bisbenzotriazoles, aminotriazoles and alkylaminotriazoles. In this context, the compounds of the substance classes mentioned can also contain substituents, such as, for example, linear or branched alkyl groups having 1 to 20 C atoms, as well as vinyl, hydroxyl, thiol or halogen radicals. In the case of bisbenzotriazoles, compounds in which the two benzotriazole groups are in each case bonded in the 6-position via a group X, wherein X can be a bond, a straight-chain alkylene group having preferably 1 to 6 carbon atoms and optionally substituted by one or more C₁- to C₄-alkyl groups, a cycloalkyl radical having at least 5 carbon atoms, a carbonyl group, a sulfonyl group or an oxygen or a sulfur atom, are preferred. Tolyltriazole is a particularly preferred corrosion protection agent for silver.

Finally, the pressed shaped bodies according to the invention can also additionally comprise fragrances and dyestuffs.

The pressed shaped bodies according to the invention preferably have the form of pellets, briquettes or tablets, but in principle are not limited in their form. The shaped bodies particularly preferably have the form of round or rectangular tablets. The size of the pressed shaped bodies according to the invention is likewise not limited in principle, and is preferably in the range of from 5 to 50 g. In the case of pressed shaped bodies which also comprise, in addition to sodium percarbonate, at least one surfactant and further constituents which are suitable for detergents and cleaning agents, the size of the shaped bodies is preferably chosen such that one shaped body comprises the amount of wash-active substances required for a washing operation in a washing machine or a dishwasher.

The pressed shaped bodies according to the invention can be produced by processes of compression agglomeration, in particular by pressing on a perforated press, roller compacting or tabletting, starting from pulverulent starting substances or starting substances in granule form. For carrying out the compression agglomeration, the pressed shaped bodies according to the invention can additionally comprise one or more binders which impart a higher strength to the shaped bodies during the compression agglomeration. Preferably, one or more constituents which are wash-active for the use in detergents or cleaning agents, for example nonionic surfactants, fulfil the function of the binder.

The pressed shaped bodies according to the invention have a better stability during storage than shaped bodies which comprise sodium percarbonate particles having a shell layer which is not built up according to the invention. During storage at elevated temperatures of from 35 to 60° C. in particular, the pressed shaped bodies according to the invention show a significantly lower loss of active oxygen content. The pressed shaped bodies according to the invention moreover also have an improved combination of strength of the shaped bodies and rate of solution of the shaped bodies in water, since the pressed shaped bodies according to the invention have a higher strength than shaped bodies produced under the same pressing conditions which comprise sodium percarbonate particles having a shell layer built up differently.

The present invention also provides a process for the production of the pressed shaped bodies according to the invention, in which a pulverulent mixture comprising coated sodium percarbonate particles is compacted by tabletting or briquetting, the coated sodium percarbonate particles having a coating with an inner shell layer comprising one or more water-soluble, hydrate-forming salts and an outer shell layer on top of this comprising an alkali metal silicate. In this context, the term pulverulent mixture also includes mixtures which comprise granules having particle dimensions up to 2 mm. In the process according to the invention, the shaped bodies are obtained without addition of water, so that superficial dissolving of the shell layer of the sodium percarbonate particles during the shaping process is avoided. The pressed shaped bodies produced by the process according to the invention simultaneously have a high strength of the shaped bodies and a high rate of solution of the shaped bodies in water.

The pressed shaped bodies according to the invention can advantageously be used in detergents and cleaning agents. In this context, the pressed shaped bodies according to the invention can be formulated as mixtures with further granules or shaped bodies to give ready-to-use detergents or cleaning agents. Such mixtures have the advantage that during storage, constituents of the mixture which are incompatible with sodium percarbonate can be contained in the further granules or shaped bodies and the storage stability of the formulated detergent or cleaning agent can be improved further in this way. By the use of pressed shaped bodies according to the invention which also comprise, in addition to sodium percarbonate, further wash-active constituents in combination with further granules or shaped bodies, the densities of the granules or shaped bodies contained in such a mixture can be co-ordinated to one another such that demixing of the constituents of the formulation can be avoided.

The pressed shaped bodies according to the invention can also be used in detergents and cleaning agents in a further embodiment in which a shaped body according to the invention is used as a portioned bleaching agent component together with a ready-formulated detergent or cleaning agent which comprises no bleaching agent.

Pressed shaped bodies according to the invention which additionally comprise at least one surfactant and optionally further substances from the series consisting of builders, alkaline components, bleaching activators, enzymes, chelating complexing agents, greying inhibitors, foam inhibitors, optical brighteners, fragrances and dyestuffs can also advantageously be used by themselves as detergents or cleaning agents. In this embodiment, the size and composition of the pressed shaped bodies according to the invention are preferably chosen such that a shaped body comprises all the wash-active substances required for a washing operation or cleaning operation.

The following examples illustrate the invention, but without limiting the subject matter of the invention.

### EXAMPLES

Preparation of Coated Sodium Percarbonate Particles

Sodium percarbonate particles which were prepared from aqueous hydrogen peroxide solution and aqueous soda solution by fluidized bed build-up granulation by the process described in WO 95/06615 and had an average particle diameter x₅₀ of 0.65 mm and a fine particle content smaller than 0.2 mm of less than 2 wt. % were employed for the preparation of coated sodium percarbonate particles. The shell layers were applied to these particles by the process described in EP-B 0 863 842 in paragraph [0021] by spraying on of aqueous solutions of the shell substances in a fluidized bed at a fluidized bed temperature of from 50 to 70° C. and simultaneously evaporating off water. Sodium sulfate was sprayed on as a 20 wt. % strength aqueous solution. Water-glass was sprayed on as a 10 wt. % strength aqueous solution of sodium water-glass having an SiO₂:Na₂O modulus of 3.3. The amounts of shell substances stated in percent by weight in the examples relate to the amount of shell substance sprayed on, calculated without water of crystallization, in relation to the total amount of sodium percarbonate particles employed and shell substances sprayed on.

Determination of the Release of Heat

The release of heat due to decomposition of sodium percarbonate was determined by microcalorimetric determination of the heat released by samples during storage at 40° C. using a TAM® Thermal Activity Monitor from Thermometric AB, Järfälla (SE). The TAM values are the measurement values determined on storage after 48 h.

Production of Dishwashing Tablets

Coated sodium percarbonate particles were mixed in a tumble mixer with a commercially available dishwashing powder which comprised 2.2 wt. % TAED but no bleaching agent, such that the mixture comprised 12.2 wt. % sodium percarbonate. The mixture was stored at room temperature for 4 days and the TAM value of the mixture was then determined. Thereafter, in each case 15 g of the mixture were pressed in a tablet press under a pressing pressure of 50 kN over a pressing time of 15 s to give parallelepipedal tablets having dimensions of 4×3×1 cm. The tablets were packed individually in plastic envelopes with a clip closure and stored in a cardboard box (dimensions 14×14×6 cm), which was closed with a hot-melt adhesive, at 50° C. for 14 days. After the storage, the active oxygen content was determined iodometrically and the retention of the active oxygen content (Oa retention) in percent was determined.

As described above, one or two shell layers were applied to sodium percarbonate particles. The shell substances used and the amounts of the shell layers are shown in Table 1. The coated sodium percarbonate particles showed TAM values in the range of from 1.7 to 2.0 μW/g. Dishwashing tablets were prepared with these coated sodium percarbonate particles as described above, and the mixture of dishwashing powder and sodium percarbonate particles employed and the tablets produced therefrom were analysed.

TABLE 1

| | | | TAM of the | |
|---|---|---|---|---|
| | Shell layer 1 | Shell layer 2 | mixture | |
| Example | [wt. %] | [wt. %] | [μW/g] | Oa retention |
| 1* | 4% Na₂SO₄ | | 34.0 | 91% |
| 2* | 0.75% WG | | 57.5 | 89% |
| 3 | 4% Na₂SO₄ | 0.75% WG | 9.6 | 95% |
| 4* | 0.75% WG | 4% Na₂SO₄ | 10.2 | 89% |

*not according to the invention
WG = sodium water-glass, modulus 3.3

The test results show that the tablets according to the invention from Example 3 show a higher storage stability with a lower loss of active oxygen than the tablets from Examples 1 and 3, which comprise sodium percarbonate having only one of the shell layers, or the tablets from Example 4, which comprise sodium percarbonate having two shell layers of the same amount and composition in the reversed sequence. The coated sodium percarbonate particles of Examples 3 and 4 showed approximately the same stability before pressing in a mixture with the other constituents, as can be seen from the similar TAM values before the pressing. On the other hand, the tablets prepared from the two mixtures by pressing under the same conditions show significantly different storage stabilities, which shows that the advantageous properties of the tablets according to the invention result from the properties of the shell layer of the sodium percarbonate particles during the pressing operation.

All references cited herein are fully incorporated by reference. Having now fully described the invention, it will be understood by those of skill in the art that the invention may be practiced within a wide and equivalent range of conditions, parameters and the like, without affecting the spirit or scope of the invention or any embodiment thereof.

What is claimed is:

1. Pressed shaped bodies comprising coated sodium percarbonate particles, wherein said sodium percarbonate particles have a coating which comprises an inner shell layer comprising one or more water-soluble, hydrate-forming salts and an outer shell layer on top of said inner shell layer comprising an alkali metal silicate.

2. The pressed shaped bodies of claim 1, wherein said outer shell layer comprises said alkali metal silicate in an amount of 0.2 to 3 wt. %, based on the coated sodium percarbonate particles.

3. The pressed shaped bodies of claim 1, wherein said water-soluble, hydrate-forming salt is selected from the group consisting of sodium sulfate, sodium carbonate, sodium bicarbonate, magnesium sulfate, and mixtures and mixed salts thereof.

4. The pressed shaped bodies of claim 3, wherein said water-soluble, hydrate-forming salt is sodium sulfate.

5. The pressed shaped bodies of claim 1, wherein said water-soluble, hydrate-forming salt makes up at least 50 wt. % of said inner shell layer.

6. The pressed shaped bodies of claim 1, wherein said inner shell layer makes up from 1 to 10 wt. % of said coated sodium percarbonate particles.

7. The pressed shaped bodies of claim 1, wherein said alkali metal silicate makes up at least 50 wt. % of said outer shell layer.

8. The pressed shaped bodies of claim 1, wherein said alkali metal silicate has a modulus of SiO₂ to M₂O (M=alkali metal) of greater than 2.5.

9. The pressed shaped bodies of claim 8, wherein said alkali metal silicate has a modulus of SiO₂ to M₂O (M=alkali metal) of from 3 to 5.

10. The pressed shaped bodies of claim 1, wherein said outer shell layer has been produced by spraying on an aqueous solution containing an alkali metal silicate in a concentration of 2 to 20 wt. %.

11. The pressed shaped bodies of claim 1, wherein said alkali metal silicate is a sodium silicate.

12. The pressed shaped bodies of claim 11, wherein said alkali metal silicate is a soda water-glass.

13. The pressed shaped bodies of claim 1, comprising 1 to 90 wt. % of said coated sodium percarbonate particles.

14. The pressed shaped bodies of claim 1, further comprising at least one surfactant.

15. The pressed shaped bodies of claim 14, further comprising at least one substance from the group consisting of builders, alkaline components, bleaching activators, enzymes, chelating complexing agents, greying inhibitors, foam inhibitors, optical brighteners, corrosion protection agents for silver, fragrances and dyestuffs.

16. A detergent comprising pressed shaped bodies according to claim 1.

17. A cleaning agent comprising pressed shaped bodies according to claim 1.

18. A process for the production of shaped bodies comprising coated sodium percarbonate particles, wherein a pulverulent mixture comprising coated sodium percarbonate particles is compacted by tabletting or briquetting, said coated sodium percarbonate particles having a coating with an inner shell layer comprising one or more water-soluble, hydrate-forming salts and an outer shell layer on top of said inner shell layer comprising an alkali metal silicate.
